(19) United States
(12) Patent Application Publication
(10) Pub. No.: US 2003/0010854 A1
(43) Pub. Date: Jan. 16, 2003

(54) Screen apparatus

(75) Inventor: Yoshihiko Aikawa, Shizuoka-shi (JP)

Correspondence Address: KANESAKA AND TAKEUCHI, 1423 Powhatan Street, Alexandria, VA, 22314, US

(73) Assignee: Aikawa Iron Works Co., Ltd.

(21) Appl. No.: 09/968,487

(22) Filed: Oct. 2, 2001

(30) Foreign Application Priority Data
Jul. 12, 2001 (JP) 2001-211687

(51) Int. Cl. B02C 23/36

(52) U.S. Cl. 241/46.17

(57) ABSTRACT

A screen apparatus includes a casing, a material supply path for supplying a paper-making material into the casing, a plurality of screens disposed in the casing, and a plurality of agitating members provided to the respective screens. The casing is divided into an inflow side of the paper-making material communicating with the material supply path and an outflow side of the cleaned papermaking material. The screen apparatus further includes a papermaking material discharge path for discharging the paper-making material passing through the plural screens and provided on the outflow side, and a foreign material discharge path for discharging foreign material which does not pass through the screens and provided at the inflow side. The screen apparatus can be made compact.

### BACKGROUND OF THE INVENTION AND RELATED ART STATEMENT

The invention relates to a screen apparatus, in particular, a screen apparatus including a plurality of screens.

Heretofore, for example, in case a paper-making material is processed by a plurality of screen apparatuses, foreign material which does not pass through a first screen apparatus is introduced into a chest through a first foreign material discharge path, and the paper-making material containing the foreign material in the chest is supplied to a second screen apparatus through a first supplying path for processing.

There have been problems such that the first and second screen apparatuses are large in size to thereby require a large installation space.

In view of the above problems, the present invention has been made and an object of the invention is to provide a screen apparatus, wherein the above-stated problems are removed.

Further objects and advantages of the invention will be apparent from the following description of the invention.

### SUMMARY OF THE INVENTION

A screen apparatus of the invention is formed by a casing; a material supply path supplying a paper-making material into the casing; a plurality of screens disposed in the casing, each having an inflow side and an outflow side of the paper-making material, at least one of the inflow sides communicating with the material supply path; a plurality of agitating members provided to the respective screens; a paper-making material discharge path formed in the casing to communicate with at least one of the outflow sides of the screens, the paper-making material discharge path discharging the paper-making material passing through one of the screens; and a foreign material discharge path formed in the casing to communicate with at least one of the inflow sides of the screens. The foreign material discharge path discharges a foreign material which can not pass through one of the screens communicating with the material supply path.

The paper-making material discharge path may communicate with the outflow sides of the respective screens to discharge the paper-making material passing through the screens outside the casing.

In the screen apparatus, the plurality of screens is arranged laterally side by side with a space therebetween. The inflow sides or the outflow sides are at least located above the screens.

In the screen apparatus, the plurality of screens includes at least a first screen, and second and third screens separated from the first screen. The inflow sides of the second and third screens communicate with the material supply path, and the outflow sides of the second and third screens communicate with the paper-making material discharge path to discharge the papermaking material passing through the second and third screens.

In the above case, the screen apparatus further includes a first passage connecting the inflow sides of the second and third screens and the inflow side of the first screen to lead the papermaking material containing a foreign material not passing through the second and third screens to the inflow side of the first screen; and a secondary paper-making material discharge path communicating with the outflow side of the first screen for discharging the paper-making material passing through the first screen. The inflow side of the first screen is connected to the foreign material discharge path for discharging the foreign material not passing through the first screen.

The screen apparatus may further includes an opening-closing valve situated in the passage for opening or closing the passage, and a control device connected to the opening-closing valve for controlling the same.

In the screen apparatus, in addition to the first to third screens as explained above, a fourth screen separated from the first, second and third screens may be provided.

In this case, the screen apparatus further includes a second passage for connecting the inflow side of the fourth screen and the inflow sides of the second and third screens, and a ternary paper-making material discharge path connected to the outflow side of the fourth screen for discharging a paper-making material passing through the fourth screen. The inflow side of the fourth screen is connected to the first passage for providing a papermaking material not passing through the fourth screen to the first screen.

### BRIEF DESCRIPTION OF THE DRAWINGS

FIG. 1 is a perspective view of a screen apparatus of an embodiment according to the present invention;

FIG. 2 is a sectional view taken along line 2-2 in FIG. 1;

FIG. 3 is a sectional view taken along line 3-3 in FIG. 2;

FIG. 4 is a sectional view of a screen apparatus of another embodiment different from the apparatus shown in FIG. 1;

FIG. 5 is a sectional view taken along line 5-5 in FIG. 4;

FIG. 6 is a side view of a screen apparatus of still another embodiment different from the apparatus shown in FIG. 4;

FIG. 7 is a sectional view taken along line 7-7 in FIG. 6;

FIG. 8 is a sectional view taken along line 8-8 in FIG. 7;

FIG. 9 is a sectional view of another screen apparatus different from the apparatus shown in FIG. 6;

FIG. 10 is a sectional view taken along line 10-10 in FIG. 9;

FIG. 11 is a side view of still another screen apparatus different from the apparatus shown in FIG. 9

FIG. 12 is a sectional view taken along line 12-12 in FIG. 11;

FIG. 13 is a sectional view taken along line 13-13 in FIG. 12;

FIG. 14 is a sectional view of a screen apparatus of the other embodiment different from the apparatus shown in FIG. 11;

FIG. 15 is a sectional view taken along line 15-15 in FIG. 14;

FIG. 16 is a side view of a screen apparatus of still another embodiment different from the apparatus shown in FIG. 14;

FIG. 17 is a sectional view taken along line 17-17 in FIG. 16;

FIG. 18 is a sectional view taken along line 18-18 in FIG. 17;

FIG. 19 is a sectional view of a screen apparatus of still another embodiment different from the apparatus shown in FIG. 16;

FIG. 20 is a sectional view taken along line 20-20 in FIG. 19;

FIG. 21 is a sectional view of a screen apparatus of still another embodiment different from the apparatus shown in FIG. 19;

FIG. 22 is a sectional view taken along line 22-22 in FIG. 21; and

FIG. 23 is a sectional view taken along line 23-23 in FIG. 21.

### DETAILED DESCRIPTION OF PREFERRED EMBODIMENTS

Hereunder, screen apparatuses of the embodiments according to the present invention are explained with reference to the drawings.

Embodiment 1

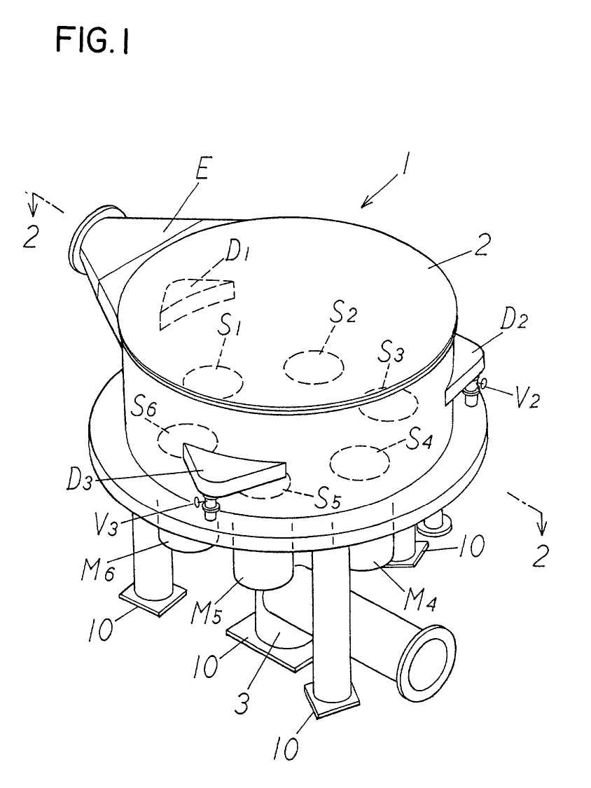

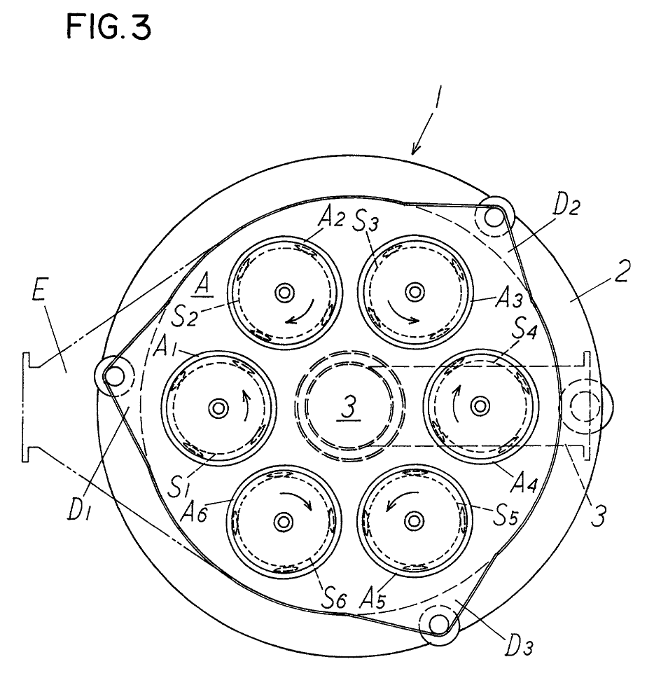

In FIGS. 1 through 3, reference numeral 1 represents a centripetal-type, i.e. external pressure-type, screen apparatus wherein a paper-making material flows from an outer side of each of the screens toward an inner side thereof to thereby clean or separate the material. The screen apparatus includes a plurality of the screens, such as S₁-S₆, and is vertically held by leg portions 10.

Reference numeral 2 represents a casing having a substantially cylindrical shape. The casing includes two layers, i.e. a layer formed of a lower member 21 and an intermediate member 22 wherein the screens S₁-S₆ are provided; and a layer formed of the intermediate member 22 and an upper member 23 wherein outflow sides of the screens S₁-S₆ are disposed. Reference numeral 24 represents poles which hold a space between the intermediate member 22 and the upper member 23.

The casing 2 is provided therein with the plurality of the screens S₁-S₆ along an outer periphery thereof. Each of the screens has a cylindrical shape, and the respective screens S₁-S₆ are provided with agitating members A₁-A₆. The agitating members may be, for example, foils and agitators.

The agitating members A₁-A₆ are rotated by motors M₁-M₆ provided to the respective agitating members A₁-A₆ to thereby prevent the screens S₁-S₆ from being clogged by the paper-making material adhered thereto. Incidentally, in the drawings, only motors M₁, M₄, M₅, M₆ among the motors M₁-M₆ are shown.

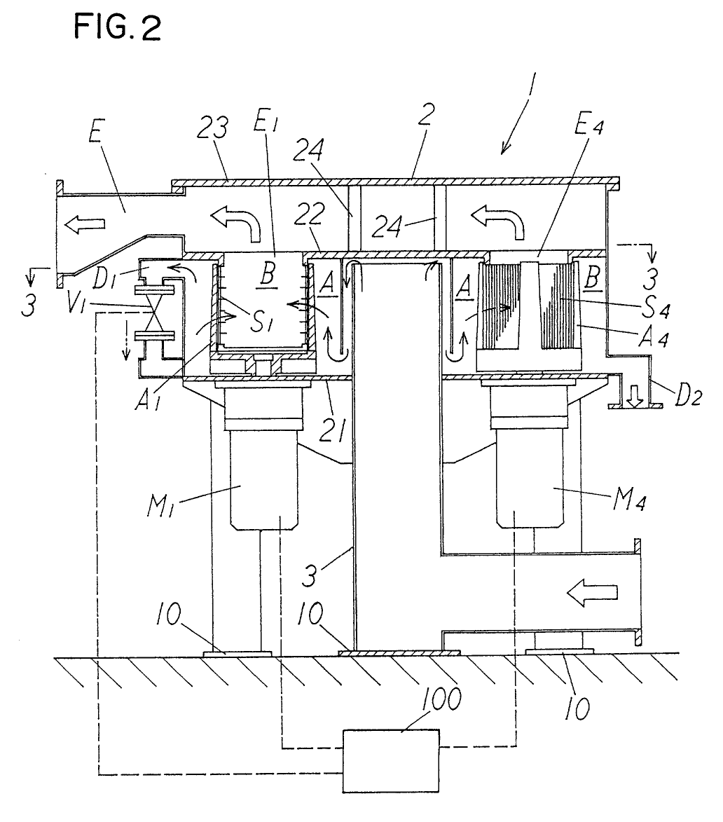

Reference numeral 3 is a material supplying path for supplying the paper-making material into the casing 2. The material supplying path 3 is communicated with the inflow side A of the paper-making material of the screens S₁-S₆. More specifically, as shown in FIG. 2, a forward end of the material supply path 3 passes through a lower central portion of the casing 2 and enters the casing 2.

The inside of the casing 2 is divided into the inflow side A of the paper-making material communicating with the material supplying path 3 and an outflow side B of the cleaned paper-making material.

The paper-making materials cleaned by or passing through the screens S₁-S₆ are discharged through cleaned paper-material discharge paths E communicating with the outflow sides B of the paper-making materials of the respective screens S₁-S₆. More specifically, the materials cleaned by the respective screens S₁-S₆ are discharged through a plurality of the cleaned material discharge paths E₁-E₆ provided at the outflow sides B, respectively. Incidentally, in the drawings, only discharge paths E₁ and E₄ are shown. The plural cleaned material discharge paths E₁-E₆ are communicated with a cleaned material discharge path E, respectively, so that the paper-making material cleaned by the screens S₁-S₆ is discharged altogether outside the casing 2 through the cleaned paper-making material discharge path E. In other words, the cleaned paper making material inside the casing 2 is discharged outside the casing 2 altogether through the cleaned material discharge path E communicating with the respective cleaned material discharge paths E₁-E₆ at one end thereof and introducing the cleaned material outside the casing 2 at the other end thereof.

Also, the foreign materials which can not be separated by the screens S₁-S₆ are discharged through foreign material discharge paths communicating with the inflow sides A of the papermaking material of the screens S₁-S₆. More specifically, the foreign materials which can not be separated by the screens S₁-S₆ are discharged through foreign material discharge paths D₁-D₃ provided on the inflow sides A. Incidentally, the foreign material discharge paths D₁-D₃ of Embodiment 1 are jointly used for the adjacent screens S₁-S₂, S₃-S₄, and S₅-S₆.

Incidentally, the plural foreign material discharge paths D₁-D₃ are provided with opening-closing valves V₁-V₃ for closing or opening the respective paths, and opening or closing of the valves V₁-V₃ and on or off of the motors M₁-M₆ are controlled by a control device 100.

Therefore, in case the paper-making material is supplied to the casing 2 through the material supply path 3, the papermaking material flows toward an outer periphery of the casing 2 from the lower center of the casing 2 to be supplied to the plural screens S₁-S₆. The paper-making material flows from the outer sides of the respective screens S₁-S₆ toward the inner sides thereof, and while good fibers in the paper-making material pass through the respective screens S₁-S₆, the foreign materials in the paper-making materials can not pass through the screens S₁-S₆ so that the good fibers can be separated from the foreign materials.

At this time, the motors M₁-M₆ are rotated, and the screens S₁-S₆ are prevented from being clogged by the agitating members A₁-A₆.

The paper-making materials cleaned by or passing through the respective screens S₁-S₆ are discharged altogether outside the casing from the cleaned paper-making material discharge path E to through the cleaned paper-making material discharge paths E₁-E₆.

Also, in case a quantity of the foreign materials in the paper-making material becomes large on the inflow sides A of the respective screens S₁-S₆, the foreign materials are discharged outside the casing 2 from the foreign material discharge paths D₁-D₃ by opening the opening-closing valves V₁-V₆ through the control device 100.

As described above, since the screen apparatus 1 includes the plural screens S₁-S₆ in the casing 2, the paper-making material can be supplied altogether to the plural screens S₁-S₆ through the paper-making material supply path 3, and the cleaned paper-making material from the plural cleaned paper-making material discharge paths E₁-E₆ is discharged altogether through the cleaned paper-making material discharge path E. Thus, the screen apparatus 1 can be made compact.

Incidentally, the screen apparatus 1 can be operated according to an amount to be treated of the paper-making material such that in case a large amount of the paper-making material is treated, for example, the motors M₁-M₆ are turned on and the screens S₁-S₆ are all operated; on the other hand, when a small amount of the paper-making material is treated, for example, the motors M₂-M₆ are turned on and the screens S₂-S₆ are used. In other words, the screen apparatus 1 can cope with an amount to be treated of the paper-making material by operating the suitable number of the screens.

Further, in case the screen apparatus is manufactured in a factory, the casing, screens and motors are made in common, so that it is possible to improve a production efficiency by standardizing the screen apparatus through selection of the number of screens to be mounted to the casing according to the processing ability of the material.

Embodiment 2

In Embodiment 1 described above, while the explanation has been made with reference to the centripetal-type, i.e. external pressure-type, wherein the paper-making material flows from the outer side of the screen toward the inner side thereof to thereby clean the material, the screen apparatus according to the invention is not limited thereto. The present invention can be also applied to a centrifugal-type, i.e. internal pressure-type, wherein the paper-making material flows from an inner side of the screen toward an outer side thereof.

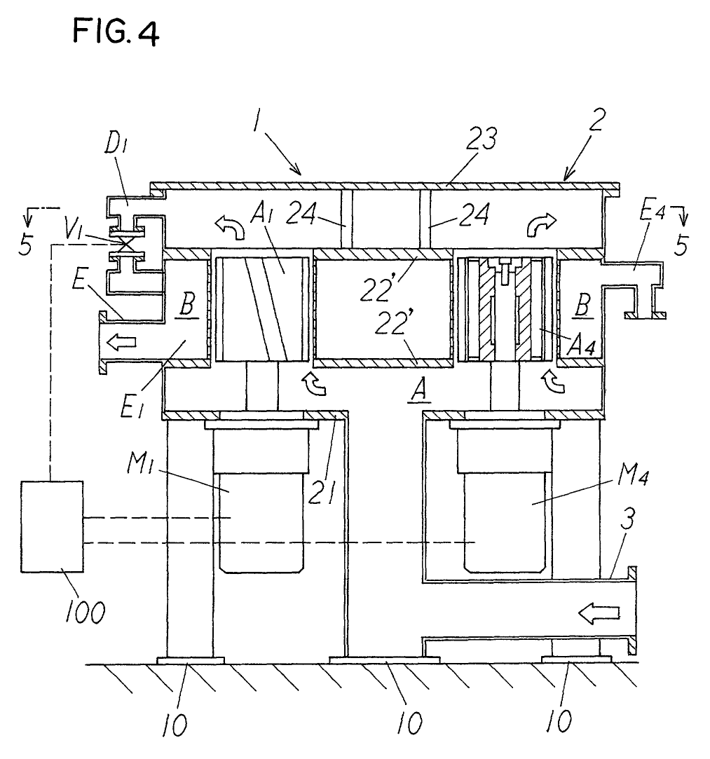

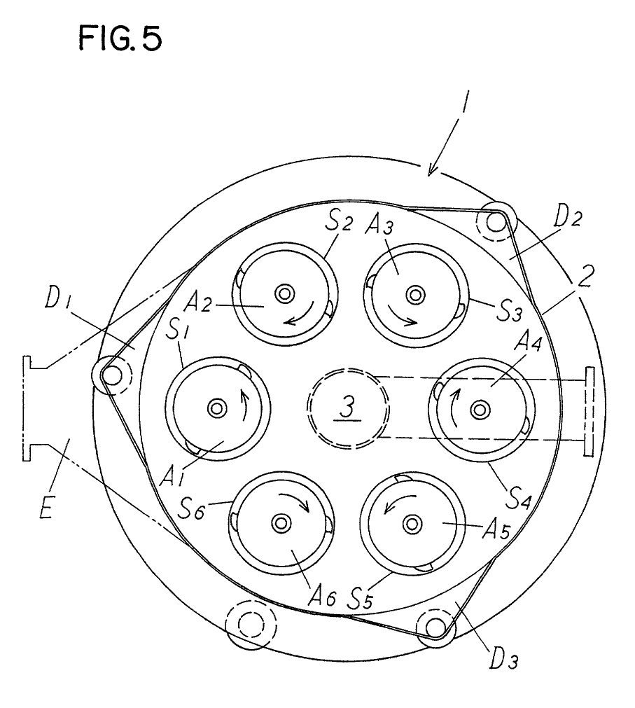

More specifically, in FIGS. 4 and 5, the agitating members A₁-A₆ are disposed inside the respective screens S₁-S₆, and the screens S₁-S₆ are positioned between the intermediate member 22′ and the intermediate member 22′. Incidentally, the same reference numerals as those in Embodiment 1 are assigned to the same portions as those in Embodiment 2, and explanations therefor are omitted.

Therefore, in case the paper-making material is supplied to the casing 2 through the material supply path 3, the papermaking material is directed to an outer periphery of the casing 2 from a lower center thereof to be supplied to the screens S₁-S₆. The paper-making material flows from an inside of each of the screens S₁-S₆ to the outside thereof. Good fibers in the papermaking material pass through the screen S₁-S₆, but foreign materials therein do not pass therethrough to thereby separate the good fibers from the foreign materials.

At that time, since the motors M₁-M₆ are rotated to rotate the agitating members A₁-A₆, the screens S₁-S₆ are prevented from being clogged.

The paper-making materials cleaned by the screens S₁-S₆ are led altogether outside the casing 2 from the cleaned papermaking material discharge path E through the respective cleaned paper-making material discharge paths E₁-E₆.

Also, when the quantity of the foreign materials in the paper-making material become large on the inflow sides A of the screens S₁-S₆, the opening-closing valves V₁-V₃ (only V₁ is shown) are opened by the control device 100, so that the foreign materials are discharged outside the casing 2 through the foreign material discharge paths D₁-D₃.

Embodiment 3

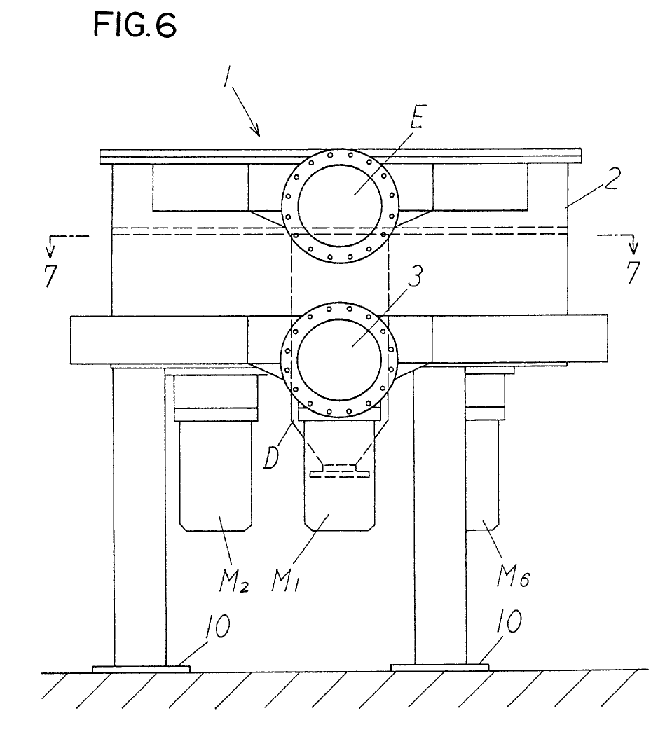

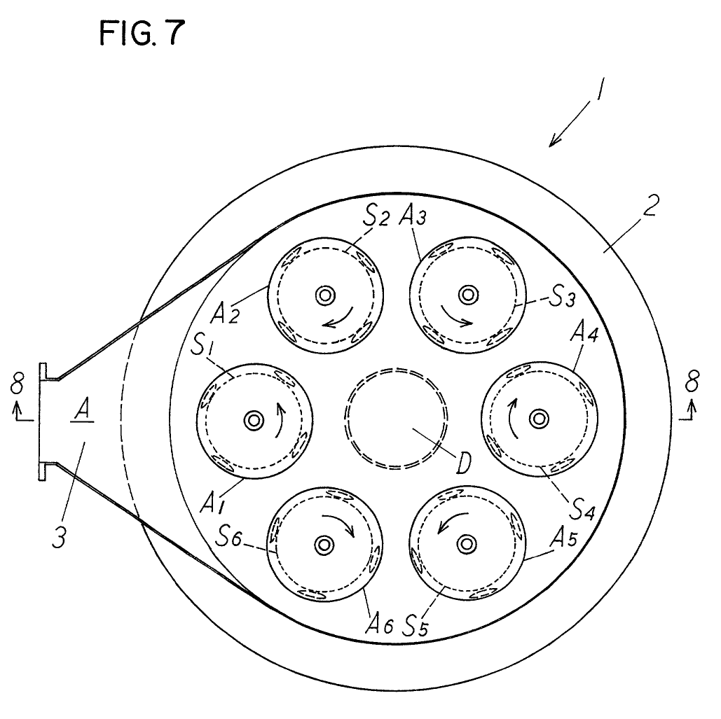

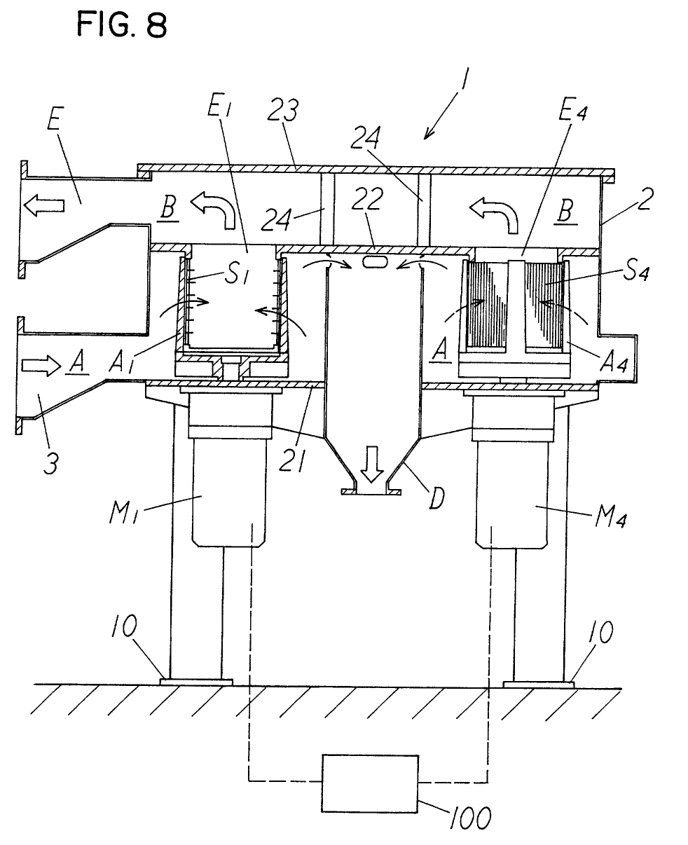

In the screen apparatus 1 as described in Embodiment 1, the paper-making material is led toward the outer periphery of the casing 2 from the lower center thereof and cleaned by the screens S₁-S₆. However, the present invention is not limited thereto. As shown in FIGS. 6 to 8, the paper-making material may be led toward an inner periphery of the casing 2 from a lower outer periphery thereof to thereby treat the paper-making material through the screens S₁-S₆.

More specifically, the screen apparatus 1 is of a centripetal type, i.e. external pressure-type, as in the screen apparatus 1 of Embodiment 1, wherein the paper-making material is led toward the inner side from the outer side of each screen to clean the paper-making material; a plurality of screens (for example, S₁-S₆) is installed therein; and leg portions 10 are provided to hold the screen apparatus (refer to FIGS. 6 to 8).

Each of the screens S₁-S₆ has, for example, a cylindrical shape; the screens S₁-S₆ have the agitating members A₁-A₆, respectively; and the respective agitating members A₁-A₆ are rotated by the motors M₁-M₆ (only motors M₁, M₂, M₄, M₆ among M₁-M₆ are shown) provided to the respective agitating members A₁-A₆ to thereby prevent the screens S₁-S₆ from being clogged by the paper-making material adhered thereto.

Reference numeral 3 represents a material supply path for supplying the paper-making material to the casing 2, and a forward end of the material supply path 3 is opened in the casing 2 to thereby direct from a lower outer periphery to an inner periphery of the casing 2. The screens S₁-S₆ are formed between the lower member 21 and the intermediate member 22 of the casing 2, and the casing 2 is divided into inflow sides A of the paper-making material and an outflow sides B of the cleaned paper-making material by the plural screens S₁-S₆.

Incidentally, the paper-making materials cleaned by or passing through the respective screens S₁-S₆ are separately discharged through a plurality of cleaned paper-making material discharge paths E₁-E₆ (only E₁ and E₄ are shown) provided on the outflow side B; and the plural cleaned paper-making material discharge paths E₁-E₆ are communicated with a cleaned paper-material discharge path E, respectively, so that the paper-making materials cleaned by the screens S₁-S₆ are altogether discharged from the path E.

Also, the foreign material which can not be separated by the screens S₁-S₆ is discharged from a foreign material discharge path D provided on the inflow side A of the paper-making material.

The foreign material discharge path D is communicated with the inflow side of the paper-making material at one end thereof and is guided outside the casing 2 at the other end thereof.

Incidentally, an opening-closing valve (not shown) for opening or closing a path is provided in the foreign material discharge path D so that the discharge path D can be controlled by the opening or closing of the opening-closing valve. The opening or closing of the valve and on or off of the motors M₁-M₆ are controlled by the control device 100.

Therefore, in case the paper-making material is supplied in the casing 2 from the material supply path 3, the paper-making material is led from the lower outer periphery of the casing 2 toward the inner periphery of the casing 2 to be supplied to the plural screens S₁-S₆.

At that time, since the motors M₁-M₆ are rotated to rotate the agitating members A₁-A₆, while preventing the screens S₁-S₆ from being clogged, the foreign material is removed from the paper-making material.

The cleaned material is led to the cleaned material discharge path E through the plural cleaned material discharge paths E₁-E₆.

When quantities of the foreign materials in the papermaking material are increased on the inflow sides A of the screens S₁-S₆, the opening-closing valve (not shown) is opened by the control device 100, and the foreign materials are discharged outside the casing 2 from the foreign material discharge path D.

Embodiment 4

In Embodiment 3 described above, the present invention is applied to the centripetal-type (external pressure-type) screen apparatus, wherein the paper-making material flows from the outer side to the inner side of each screen to thereby clean the material. The present invention is not limited thereto, and the screen apparatus of the invention can also be applied to a centrifugal-type (internal pressure-type) screen apparatus, wherein the paper-making material flows from the inner side to the outer side of each screen to thereby clean the paper-making material.

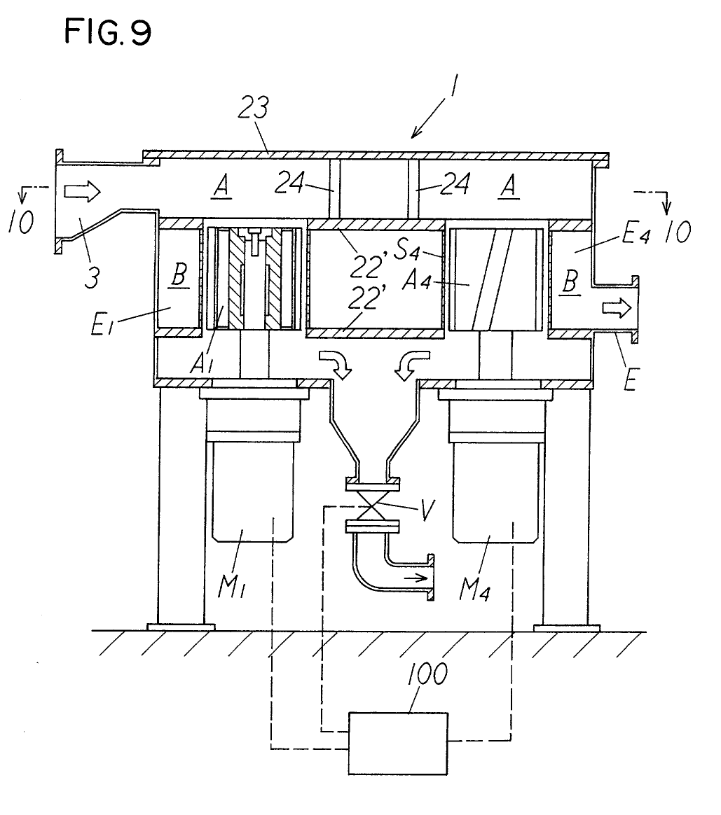

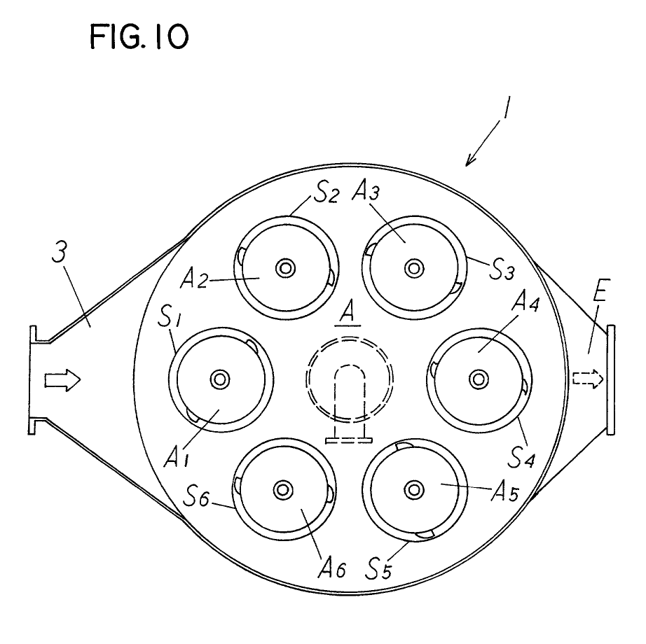

More specifically, in FIGS. 9 and 10, the agitating members A₁-A₆ are disposed in the respective screens S₁-S₆, and the screens S₁-S₆ are located between the intermediate member 22′ and the intermediate member 22′. Incidentally, in Embodiment 4, the same reference numerals as those in Embodiment 3 are assigned to the same portions as in Embodiment 3, and explanations therefor are omitted.

In case the paper-making material is supplied to the casing 2 through the material supply path 3, the paper-making material is led to an upper center from an outer periphery of the casing 2 to be supplied to a plurality of screens S₁-S₆. The paper-making material flows from the inner side to the outer side of each of the screens S₁-S₆, so that good fibers in the papermaking material pass through the screens S₁-S₆, and the foreign materials in the paper-making material can not pass therethrough to thereby separate the good fibers from the foreign materials. At that time, the motors M₁-M₆ are rotated to rotate the agitating members A₁-A₆ to thereby prevent the screens S₁-S₆ from being clogged.

The paper-making materials cleaned by the screens S₁-S₆ are discharged outside the casing 2 altogether from the cleaned paper-making material discharge path E through a plurality of cleaned paper-making material discharge paths E₁-E₆ (only E₁ and E₄ are shown). The foreign materials which can not pass through the screens S₁-S₆ are discharged from the foreign material discharge path D provided on the inflow side A of the paper-making material.

The foreign material discharge path D is communicated with the inflow side A of the paper-making material at one end thereof, and is guided outside the casing 2 at the other end thereof. An opening-closing valve V for opening or closing a passage is provided in the foreign material discharge path D, and opening and closing of the opening-closing valve V can be controlled by the control device 100.

Therefore, when quantities of the foreign materials in the paper-making material become large on the inflow sides A of the screens S₁-S₆, the closing-opening valve V is opened by the control device 100 to discharge the foreign materials outside the casing 2 through the foreign material discharge path D.

Embodiment 5

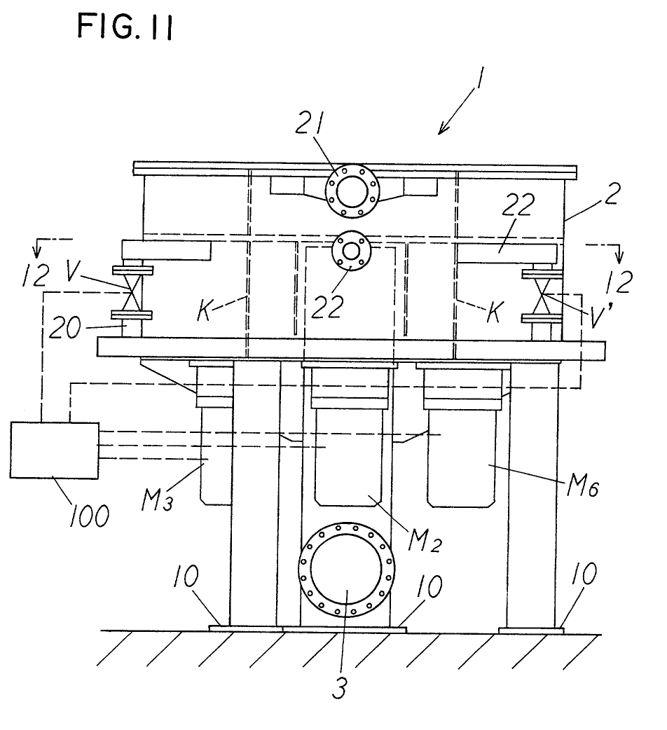

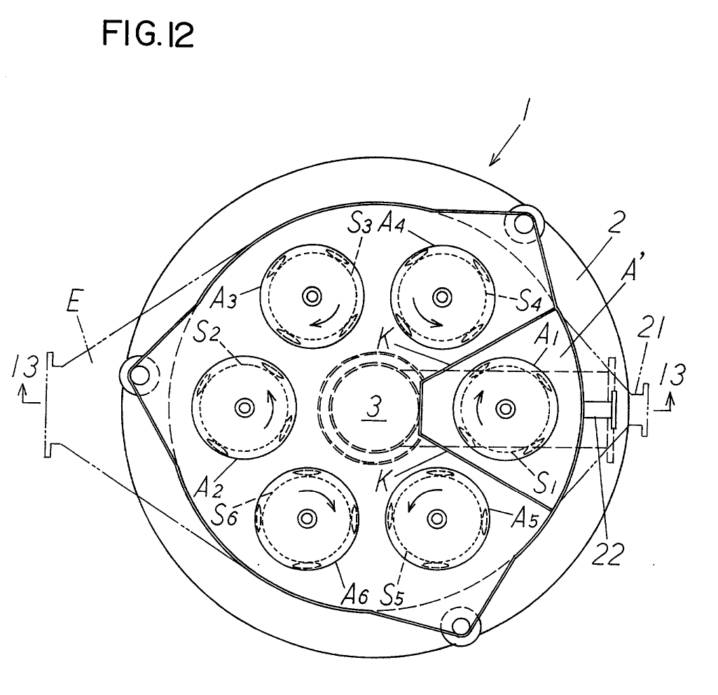

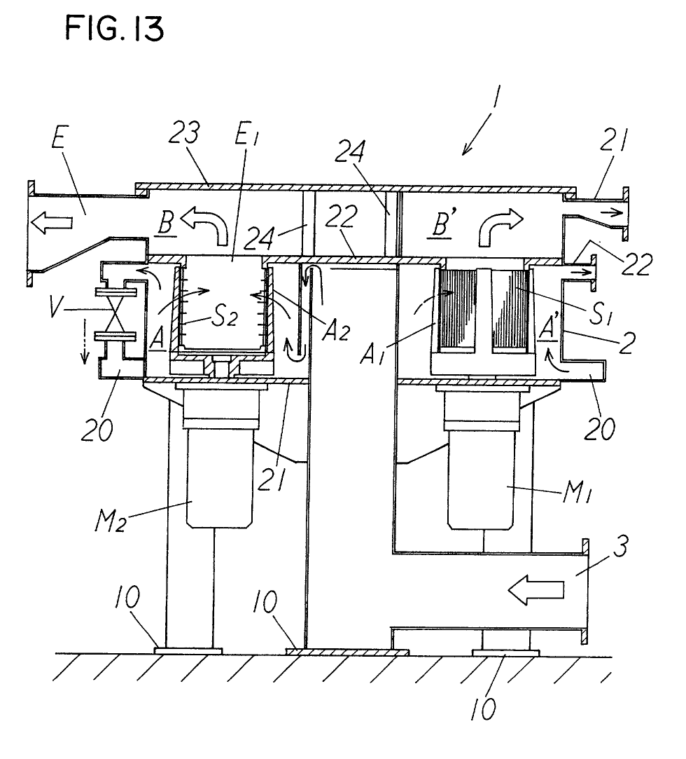

In the screen apparatuses of Embodiments 1 through 4 described above, the paper-making material is supplied to the plural screens S₁-S₆ in parallel to clean the paper-making material. However, in the present embodiment, the paper-making material including foreign materials which can not pass through the second screen S₂ to the sixth screen S₆ out of the plurality of the screens is led to the first screen S₁ through a passage 20 to further clean the paper-making material (refer to FIGS. 11 to 13).

Reference numeral 1 denotes a screen apparatus. The screen apparatus 1 is of a centripetal-type (external pressure-type), includes a plurality of screens S₁-S₆, and is held by leg portions 10.

Reference numeral 2 denotes a casing; the casing 2 has a substantially cylindrical shape; and the plural screens S₁-S₆ are disposed in the casing 2 along an outer periphery thereof.

The screens S₁-S₆ have, for example, a cylindrical shape, respectively. The screens S₁-S₆ have agitating members A₁-A₆, respectively; and the agitating members A₁-A₆ are rotated by motors M₁-M₆ (only motors M₁, M₂, M₃, M₆ are shown) provided thereto, respectively, to thereby prevent the screens S₁-S₆ from being clogged by the paper-making material adhered thereto.

Reference numeral 3 is a material supply path for supplying the paper-making material to the casing 2. The material supply path 3 is communicated with inflow sides A of the papermaking material of the second to sixth screens S₂-S₆ except for the first screen S₁. Specifically, the forward end of the material supply path 3 passes through a lower center of the casing 2 and enters the casing 2.

The first screen S₁ is isolated from the second to sixth screens S₂-S₆ by isolating walls K provided in the casing 2.

The casing 2 is divided into an inflow side A of the paper-making material and an outflow side B of the cleaned papermaking material by the second to sixth screens S₂-S₆; and an inflow side A′ of the paper-making material and an outflow side B′ of the cleaned paper-making material by the first screen S₁.

Incidentally, the paper-making materials cleaned by the second to sixth screens S₂-S₆ are discharged from a first cleaned paper-making material discharge path E provided on the outflow side B. The first cleaned paper-making material discharge path E is communicated with the outflow side B of the paper-making material cleaned at the second to sixth screens S₂-S₆ to thereby discharge the paper-making materials cleaned at the second to sixth screens S₂-S₆ outside the casing 2.

Also, the paper-making material containing first foreign material which can not be separated by the second to sixth screens S₂-S₆ is led to the first screen S₁ through a passage 20 for connecting the inflow side A of the paper-making material of the second to sixth screens S₂-S₆ and an inflow side A′ of the papermaking material of the first screen S₁.

Incidentally, the passage 20 is provided with an opening-closing valve V, and opening or closing of the valve V and on or off of the motors M₁-M₆ are controlled by the control device 100.

Reference numeral 21 represents a second cleaned papermaking material discharge path discharging the paper-making material cleaned by the first screen S₁, and disposed on the outflow side B′ of the first screen S₁. Reference numeral 22 is a second foreign material discharge path discharging the second foreign material which can not be separated by the first screen S₁, and communicated with the inflow side A′ of the paper-making material of the first screen S₁.

Therefore, in case the paper-making material is supplied to the casing 2 through the material supply path 3, the papermaking material is directed toward the outer periphery of the casing 2 from a lower center thereof to be supplied to the second to sixth screens S₂-S₆.

At that time, since the motors M₂-M₆ are rotated to rotate the agitating members A₂-A₆, while preventing the screens S₂-S₆ from being clogged, foreign materials are removed from the paper-making material. The paper-making material cleaned by the second to sixth screens S₂-S₆ is led outside the casing 2 through the first cleaned paper-making material discharge path E.

Incidentally, when a quantity of the foreign materials in the paper-making material becomes large on the inflow sides A of the second to sixth screens S₂-S₆, the opening-closing valve V is opened and the motor M₁ is rotated by the control device 100, so that the paper-making material containing the first foreign materials which can not be separated by the second to sixth screens S₂-S₆ are led to the inflow side A′ of the paper-making material of the first screen S₁ through the passage 20. Then, the papermaking material cleaned by the first screen S₁ is discharged outside the casing 2 through the second cleaned paper-making material discharge path 21. Also, according to a state of the foreign materials on the inflow side A′ of the first screen S₁, for example, when the quantity of the foreign materials on the inflow side A′ of the first screen S₁ is large, the opening-closing valve V′ provided to the second foreign material discharge path 22 is controlled by the control device 100 to be opened to thereby discharge the foreign materials outside the casing 2 through the second foreign material discharge path 22.

As described above, the screen apparatus 1 includes the plural screens S₁-S₆ in the casing 2, and is structured such that the paper-making material is supplied altogether to the plural screens S₂-S₆ except for the first screen S₁ through the material supply path 3 and the paper-making material cleaned by the plural screens S₂-S₆ except for the first screen S₁ is discharged altogether through the first cleaned paper-making material discharge path E. Thus, the screen apparatus 1 can be made compact.

Incidentally, the screen apparatus 1 can be operated according to an amount to be treated of the paper-making material such that in case a large amount of the paper-making material is treated, for example, the motors M₁-M₆ are turned on and the screens S₁-S₆ are all operated; on the other hand, when a small amount of the paper-making material is treated, for example, the motors M₂-M₆ are turned on and the screens S₂-S₆ are used. In other words, the screen apparatus 1 can cope with the amount to be treated of the paper-making material by operating the suitable number of the screens.

Embodiment 6

Although, in Embodiment 5 described above, there has been explained the centripetal-type (external pressure-type) screen apparatus wherein the paper-making material flows from the outside toward the inside of each screen to thereby clean the material, the present invention is not limited thereto, and is also applied to a centrifugal-type (internal pressure-type) screen apparatus wherein the paper-making material flows from the inside toward the outside of each screen to thereby clean the material.

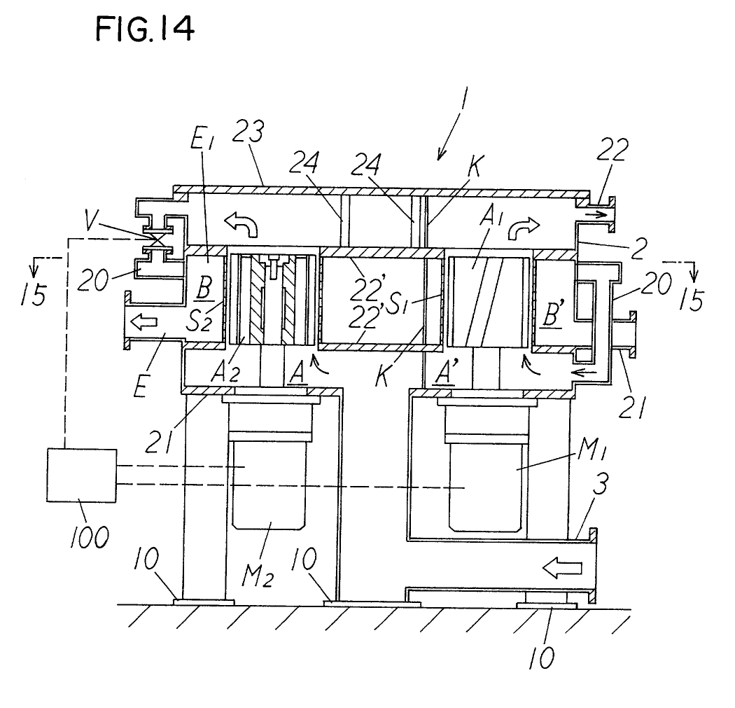

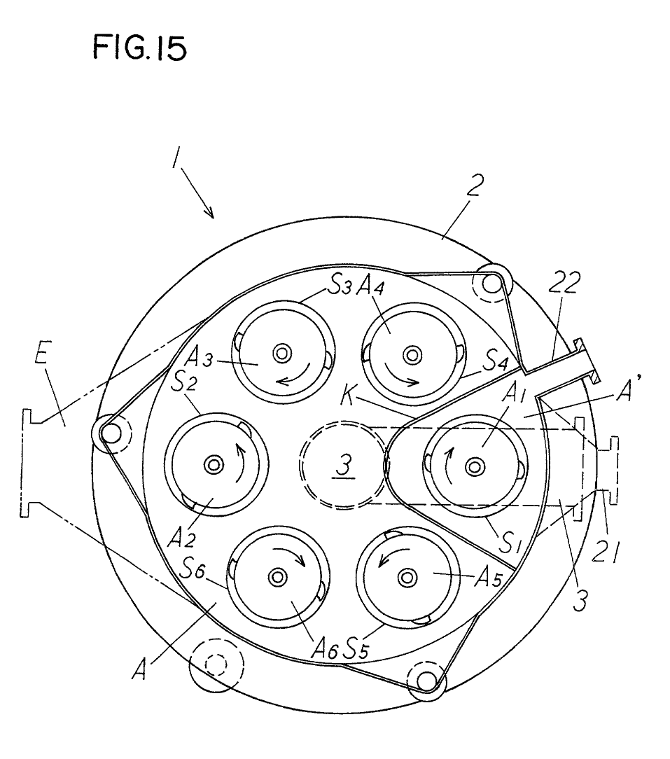

More specifically, in FIGS. 14 and 15, the agitating members A₁-A₆ are located inside the screens S₁-S₆, respectively, and the screens S₁-S₆ are disposed between the intermediate member 22′ and the intermediate member 22′. In Embodiment 6, the same reference symbols as those in Embodiment 5 are assigned to the same parts as those in Embodiment 5 and explanations therefor are omitted.

Therefore, in case the paper-making material is supplied into the casing 2 through the material supply path 3, the papermaking material is directed toward the outer periphery of the casing 2 from the lower center thereof to be supplied to the second to sixth screens S₂-S₆.

The paper-making material flows from the inner side to the outer side of each screen of the second to sixth screens S₂-S₆, and while good fibers in the paper-making material pass through the second to sixth screens S₂-S₆, the foreign materials in the paper-making material do not pass through the second to sixth screens S₂-S₆ to thereby separate the good fibers from the foreign materials.

At that time, since the motors M₂-M₆ are rotated to rotate the agitating members A₂-A₆, while preventing the second to sixth screens S₂-S₆ from being clogged, the foreign materials are removed from the paper-making material. The paper-making material cleaned by the second to sixth screens S₂-S₆ is led outside the casing 2 through a first cleaned paper-making material discharge path E.

Incidentally, when quantities of the foreign materials in the paper-making material on the inflow sides A of the second to sixth screens S₂-S₆ are increased, an opening-closing valve V is opened and the motor M₁ is rotated by the control device 100, so that the paper-making material containing the first foreign materials which can not be separated by the second to sixth screens S₂-S₆ is led to the inflow side A′ of the paper-making material of the first screen S₁ through the passage 20. Then, the papermaking material cleaned by the first screen S₁ is discharged outside the casing 2 through the second cleaned paper-making material discharge path 21. Also, according to a state of the foreign materials on the inflow side A′ of the first screen S₁, for example, when the quantity of the foreign material on the inflow side A′ of the first screen S₁ is increased, the opening-closing valve (not shown) provided to the second foreign material discharge path 22 is controlled by the control device 100 to be opened to thereby discharge the foreign material outside the casing 2 through the second foreign material discharge path 22.

Embodiment 7

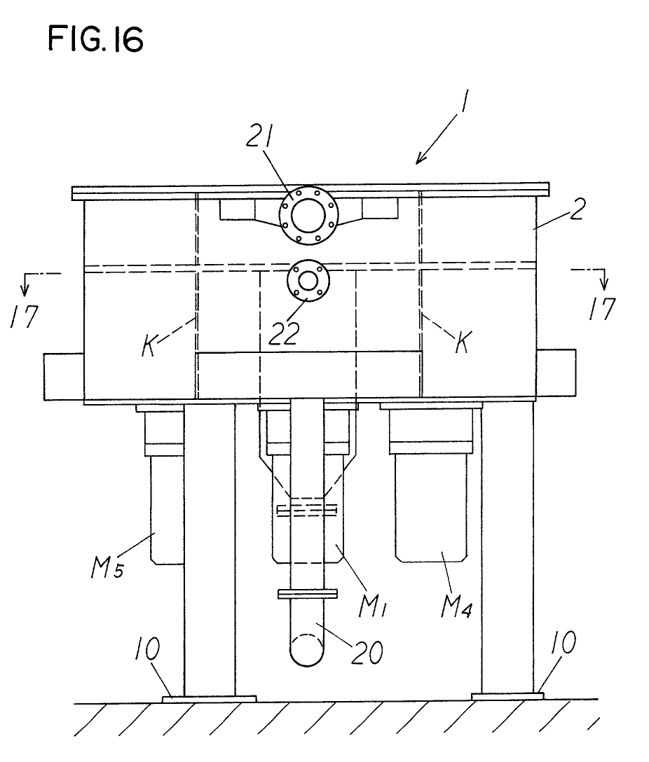

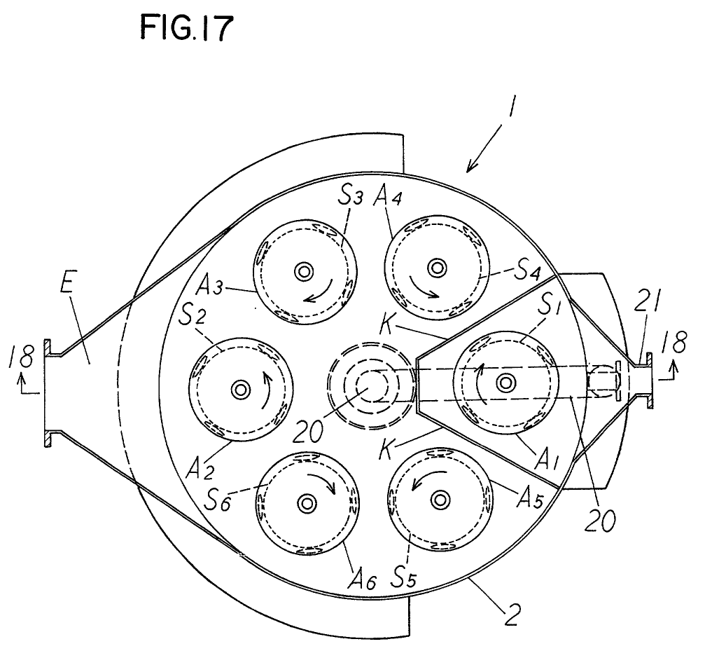

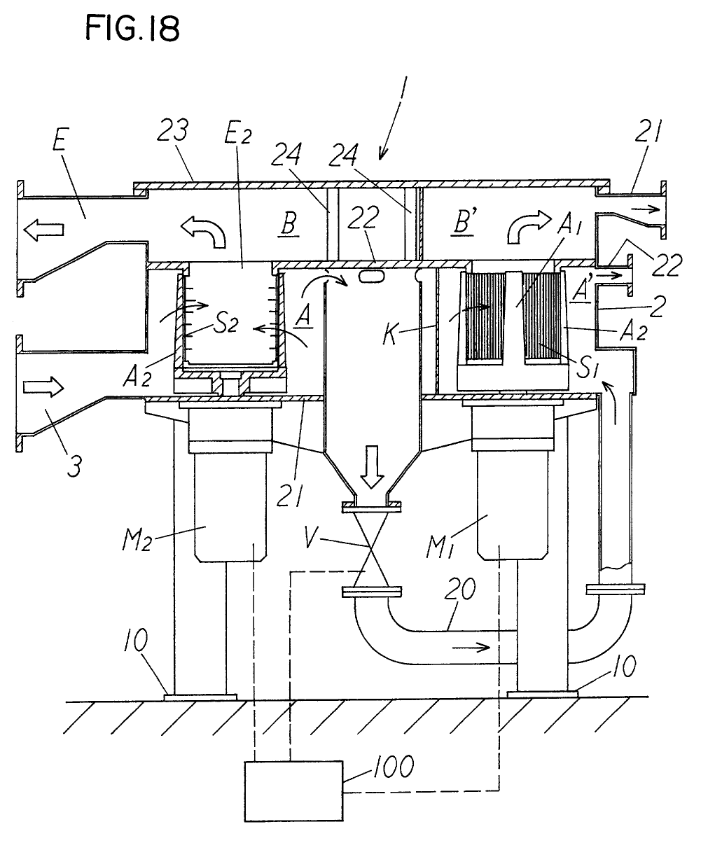

In the screen apparatuses 1 of Embodiments 5 and 6 described above, the paper-making material is directed to the outer periphery of the casing 2 from the lower center thereof, and is cleaned by the plural screens S₂-S₆. However, the present invention is not limited thereto, and the paper-making material may be directed toward an inner periphery of the casing 2 from a lower outer periphery thereof to clean the paper-making material by a plurality of screens S₂-S₆, as shown in FIGS. 16 to 18.

Reference numeral 1 denotes a screen apparatus. The screen apparatus 1 is of a centripetal-type (external pressure-type) wherein the paper-making material flows from an outer side to an inner side of each screen to clean. The screen apparatus includes the plural screens S₁-S₆, and is vertically held by leg portions 10.

Reference numeral 2 represents a casing having a substantially cylindrical shape. The casing 2 is provided therein with the plural screens S₁-S₆ along an outer periphery of the casing 2.

The screens S₁-S₆, for example, have a cylindrical shape and are provided with a plurality of agitating members A₁-A₆, respectively. The agitating members A₁-A₆ are rotated by motors M₁-M₆ (only M₁, M₂, M₄, M₅ are shown out of M₁-M₆) provided thereto, respectively, to thereby prevent the screens S₁-S₆ from being clogged by the paper-making material adhered thereto.

Reference numeral 3 represents a material supply path for supplying the paper-making material into the casing 2, and a forward end of the material supply path 3 enters a lower outer periphery of the casing 2 to supply the paper-making material to the inside of the casing 2.

The first screen S₁ is isolated from the other second to sixth screens S₂-S₆ by isolating walls K provided in the casing 2.

Also, the casing 2 is divided into an inflow side A of a paper-making material and an outflow side B of the cleaned papermaking material by the second to sixth screens S₂-S₆; and an inflow side A′ of the paper-making material and an outflow side B′ of the cleaned paper-making material by the first screen S₁. Then, the inflow side A of the paper-making material of the second to sixth screens S₂-S₆ is communicated with the material supply path 3.

Incidentally, the paper-making materials cleaned by the second to the sixth screens S₂-S₆ except for the first screen S₁ are discharged through a first cleaned paper-making material discharge path E provided to the outflow side B. The first cleaned paper-making material discharge path E is communicated with the outflow side B of the paper-making material cleaned by the second to sixth screens S₂-S₆ to thereby discharge the paper-making materials cleaned by the second to sixth screens S₂-S₆ outside the casing altogether.

Also, the paper-making material containing the first foreign materials which can not be separated by the second to sixth screens S₂-S₆ except for the first screen S₁ is led to the first screen S₁ through a passage 20 connecting the inflow side A of the paper-making material of the second to sixth screens S₂-S₆ and the inflow side A′ of the paper-making material of the first screen S₁.

Incidentally, the passage 20 is provided with an opening-closing valve V for opening or closing the passage, and the opening or closing of the opening-closing valve V and on or off of the motors M₁-M₆ are controlled by the control device 100.

Reference numeral 21 represents a second cleaned papermaking material discharge path for discharging the paper-making material cleaned by the first screen S₁, and provided on the outflow side B′ of the paper-making material of the first screen S₁. Numeral 22 is a second foreign material discharge path for discharging the second foreign material which can not be separated by the first screen S₁.

Therefore, when the paper-making material is supplied into the casing 2 through the material supply path 3, the papermaking material is directed toward the inside of the casing from the lower outer periphery to be supplied to the second to sixth screens S₂-S₆.

At that time, since the motors M₂-M₆ are rotated to rotate the agitating members A₂-A₆, while preventing the second to sixth screens S₂-S₆ from being clogged, the foreign materials are removed from the paper-making material. The paper-making materials cleaned by the second to sixth screens S₂-S₆ are led outside the casing 2 through the first cleaned paper-making material discharge path E.

Incidentally, when quantities of the foreign materials in the paper-making material on the inflow sides A of the second to sixth screens S₂-S₆ become large, the opening-closing valve V is opened and the motor M₁ is rotated by the control device 100, so that the paper-making material containing the first foreign materials which can not be separated by the second to sixth screens S₂-S₆ is led to the inflow side A′ of the paper-making material of the first screen S₁ through the passage 20. Then, the papermaking material cleaned by the first screen S₁ is discharged outside the casing 2 through the second cleaned paper-making material discharge path 21. Also, according to a state of the foreign material on the inflow side A′ of the first screen S₁, for example, when the quantity of the foreign materials on the inflow side A′ of the first screen S₁ is large, the opening-closing valve (not shown) provided to the second foreign material discharge path 22 is controlled by the control device 100 to be opened to thereby discharge the foreign material outside the casing 2 through the second foreign material discharge path 22.

As described above, the screen apparatus 1 includes the plural screens S₁-S₆ in the casing 2, and is structured such that the paper-making material is supplied altogether to the plural screens S₂-S₆ except for the first screen S₁ through the material supply path 3 and the paper-making material cleaned by the plural screens S₂-S₆ except for the first screen S₁ is discharged altogether through the first cleaned paper-making material discharge path E. Thus, the screen apparatus 1 can be made compact.

Incidentally, the screen apparatus 1 can be operated according to an amount to be treated of the paper-making material such that in case a large amount of the paper-making material is treated, for example, the motors M₁-M₆ are turned on and the screens S₁-S₆ are all operated; on the other hand, when a small amount of the paper-making material is treated, for example, one of the motors M₁-M₆ is turned off (for example, the motor M₂ is turned off and the motor M₁ and motors M₃-M₆ are turned on), and the screen S₁ and the screens S₃-S₆ are used. In other words, the screen apparatus 1 can cope with the amount to be treated of the paper-making material by operating the suitable number of the screens.

Embodiment 8

In Embodiment 7 described above, the present invention is applied to a centripetal-type (external pressure-type) screen apparatus wherein the paper-making material flows from the outer side to the inner side of each screen to thereby clean the paper material. However, the present invention is not limited thereto, and is also applied to a centrifugal-type (internal pressure-type) screen apparatus wherein the paper-making material flows from the inner side to the outer side of each screen.

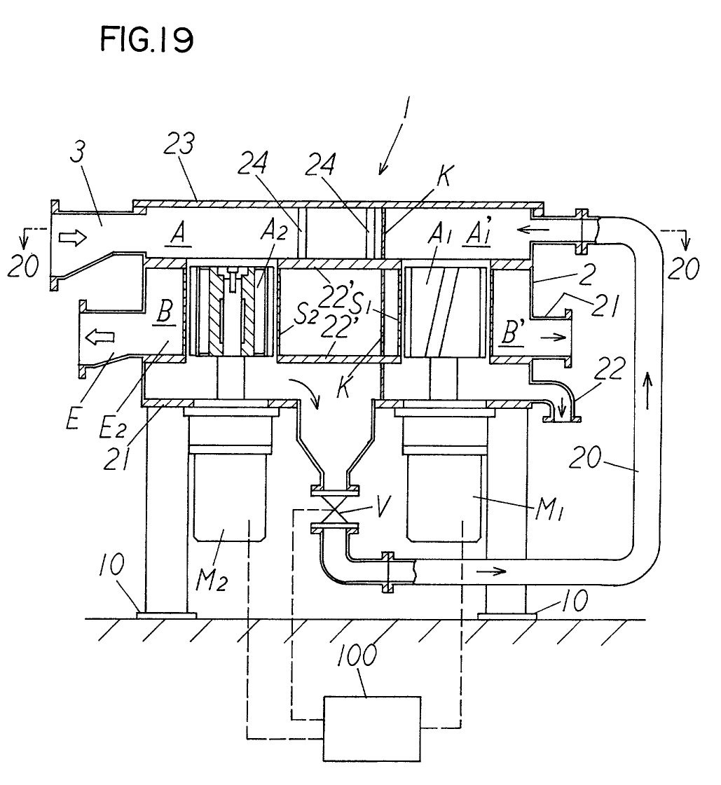

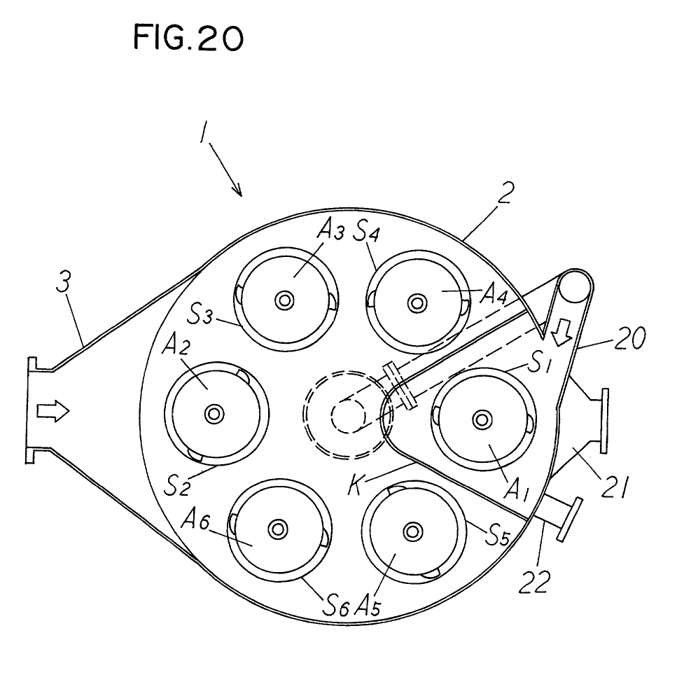

More specifically, in FIGS. 19 and 20, the agitating members A₁-A₆ are located inside the screens S₁-S₆, respectively and the screens S₁-S₆ are disposed between the intermediate member 22′ and the intermediate member 22′. In Embodiment 8, the same symbols as those in Embodiment 7 are assigned for the same parts as those in Embodiment 7 and explanations therefor are omitted.

Therefore, in case the paper-making material is supplied into the casing 2 through the material supply path 3, the papermaking material is directed toward the center from the upper outer periphery of the casing 2 to be supplied to the second to sixth screens S₂-S₆.

The paper-making material flows from the inner side to the outer side of each screen of the second to the sixth screens S₂-S₆, and while good fibers in the paper-making material pass through the second to sixth screens S₂-S₆, the foreign materials in the paper-making material do not pass through the second and sixth screens S₂-S₆ to thereby separate the good fibers from the paper-making material.

At that time, since the motors M₂-M₆ are rotated to rotate the agitating members A₂-A₆, while preventing the second to sixth screens S₂-S₆ from being clogged, the foreign materials are removed from the paper-making material. The paper-making material cleaned by the second to sixth screens S₂-S₆ is led outside the casing 2 through the first cleaned paper-making material discharge path E.

Incidentally, when quantities of the foreign materials in the paper-making material on the inflow sides A of the second to sixth screens S₂-S₆ become large, the opening-closing valve V is opened and the motor M₁ is rotated by the control device 100, so that the paper-making material containing the first foreign materials which can not be separated by the second to sixth screens S₂-S₆ is led to the inflow side A′ of the paper-making material of the first screen S₁ through the passage 20. Then, the papermaking material cleaned by the first screen S₁ is discharged outside the casing 2 through the second cleaned paper-making material discharge path 21. Also, according to a state of the foreign material on the inflow side A′ of the first screen S₁, for example, when the quantity of the foreign material on the inflow side A′ of the first screen S₁ is large, the opening-closing valve (not shown) provided to the second foreign material discharge path 22 is controlled by the control device 100 to be opened to thereby discharge the foreign material outside the casing 2 through the second foreign material discharge path 22.

While, in Embodiments 5 to 8 described above, six screens S₁-S₆ are provided, the present invention is not limited thereto. In the present invention, at least three screens, i.e. the first, second and third screens S₁-S₃, are required, wherein the first screen S₁ is isolated by isolating walls K from the second and third screens S₂ and S₃; and at least three agitating members, such as the first agitating member A₁ for the first screen S₁, second agitating member A₂ for the second screen S₂ and the third agitating member A₃ for the third screen S₃, are required. Further, a plurality of motors which rotate the agitating members, such as a first motor M₁ for the first agitating member A₁, a second motor M₂ for the second agitating member A₂ and a third motor M₃ for the third agitating member A₃, is required. In this case, the control device 100 controls the on or off operations of the first to third motors M₁-M₃.

Embodiment 9

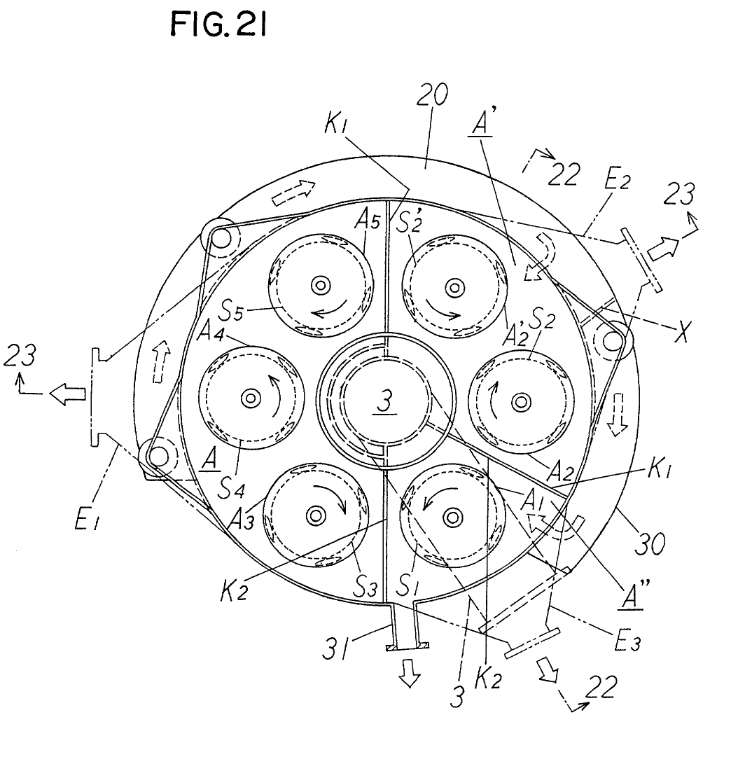

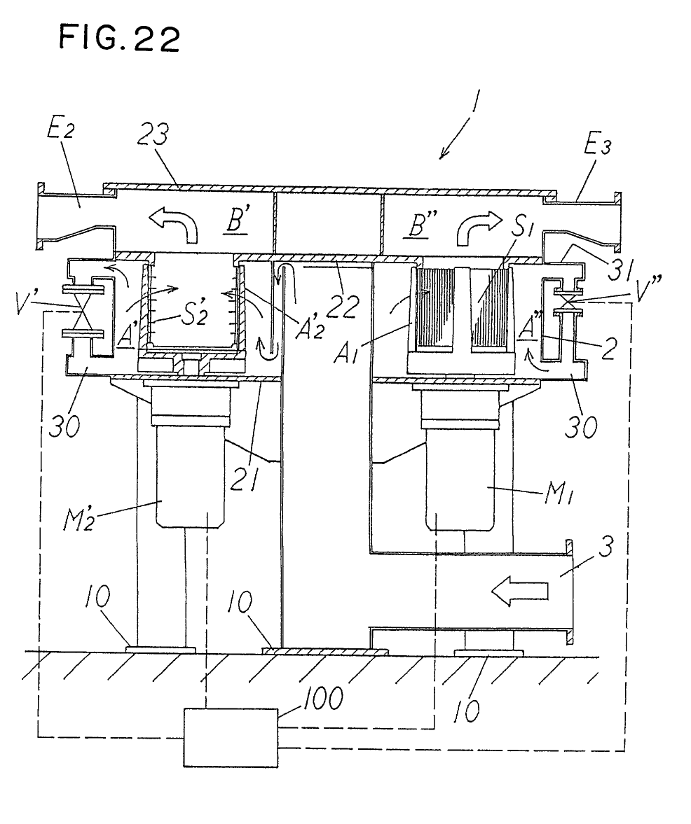

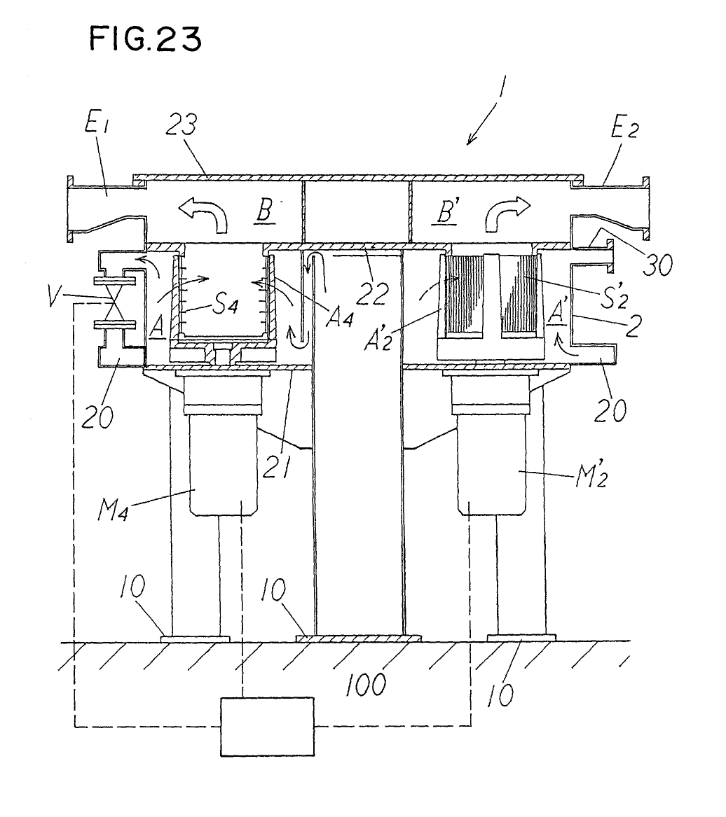

In the screen apparatuses 1 of Embodiments 5 to 8 described above, the paper-making material containing the foreign materials which can not be separated by the second to sixth screens S₂-S₆ is led to the first screen S₁ through the passage 20 and, at the same time, the paper-making material containing the foreign materials which can not be separated by the first screen S₁ (the secondary screen) is discharged outside the casing 2 to be treated. However, in the following embodiment, a description is given about a screen apparatus wherein the paper-making material containing the foreign materials which can not be separated by the secondary screen is subjected to a cleaning treatment by the tertiary screen (refer to FIGS. 21 to 23).

Reference numeral 1 represents a screen apparatus of a centripetal-type, wherein the paper-making material flows from the outside to the inside of each of a plurality of screens, i.e. the first screen S₁, second screen S₂, S′₂, third screen S₃, fourth screen S₄ and fifth screen S₅ (hereinafter referred to as “S₁-S₅”), provided therein. The screen apparatus is held vertically by leg portions 10.

Reference numeral 2 represents a casing having a substantially cylindrical shape. The casing 2 is provided therein with a plurality of the screens S₁-S₅ along an outer periphery of the casing 2.

The plural screens S₁-S₅, for example, have cylindrical shapes, respectively. The screens S₁-S₅ are provided with a plurality of agitating members, respectively, for example, the first agitating member A₁ for the first screen S₁, the second agitating member A₂ for the second screen S₂, the second agitating member A′₂ for the second screen S′₂, the third agitating member A₃ for the third screen S₃, the fourth agitating member A₄ for the fourth screen S₄ and the fifth agitating member A₅ for the fifth screen S₅, (hereinafter referred to as “agitating members A₁-A₅”); and the agitating members A₁-A₅ are rotated by motors, for example, the first motor M₁ for the first agitating member A₁, the second motor M₂ for the second agitating member A₂, the second motor M′₂ for the second agitating member A′₂, the third motor M₃ for the third agitating member A₃, the fourth motor M₄ for the fourth agitating member A₄ and the fifth motor M₅ for the fifth agitating member A₅ (hereinafter referred to as “motors M₁-M₅”), provided to the respective agitating members A₁-A₅ (in the drawings, the motors M₁, M′₂ and M₄ out of the motors M₁-M₅ are shown). Thus, the screens S₁-S₅ are prevented from being clogged by the papermaking material adhered thereto.

Reference numeral 3 is a material supply path for supplying the paper-making material to the casing 2. The material supply path 3 is communicated with an inflow side A of the papermaking material of the third screen S₃, the fourth screen S₄ and the fifth screen S₅. Specifically, the forward end of the material supply path 3 passes through a lower center in the casing 2 and enters the casing 2.

The second screen S₂ and the second screen S′₂ are isolated from the other first screen S₁, third screen S₃, the fourth screen S₄ and the fifth screen S₅ by the first isolating walls K₁ provided in the casing 2; and the first screen S₁ is isolated from the second screen S₂, the second screen S′₂, the third screen S₃, the fourth screen S₄ and the fifth screen S₅ by the second isolating walls K₂ provided in the casing 2.

Incidentally, while a portion of the first isolating wall K₁ is used as a portion of the second isolating wall K₂, the first and second isolating walls K₁ and K₂ may be provided separately.

Also, the casing 2 is divided into an inflow side A of the paper-making material and an outflow side B of the cleaned paper-making material, of the third screen S₃, the fourth screen S₄ and the fifth screen S₅ by the third, fourth and fifth screens S₃-S₅; an inflow side A′ of the paper-making material and an outflow side B′ of the cleaned paper-making material, of the second screen S₂ and the second screen S′₂ by the second screen S₂ and the second screen S′₂; and an inflow side A′ of the paper-making material of the first screen S₁ and an outflow side B′ of the cleaned papermaking material, respectively.

The inflow side A of the paper-making material of the third to fifth screens S₃-S₅ is communicated with the material supply path 3.

The paper-making material cleaned by the third to fifth screens S₃-S₅ is discharged through the first cleaned paper-making material discharge path E₁ provided on the outflow side B of the paper-making material of the third to fifth screens S₃-S₅.

Incidentally, the first cleaned paper-making material discharge path E₁ is communicated with the outflow side B of the paper-making material cleaned by the third to fifth screens S₃-S₅ to thereby discharge the paper-making material cleaned by the third to fifth screens S₃-S₅ outside the casing 2.

The paper-making material containing the first foreign materials which can not be separated by the third to fifth screens S₃-S₅ is led to the second screen S₂ and the second screen S′₂ through the first passage 20 connecting the inflow side A of the paper-making material of the third to fifth screens S₃-S₅ and the inflow side A′ of the paper-making material of the second screen S₂ and the second screen S′₂.

Incidentally, the first passage 20 is provided with an opening-closing valve V for opening or closing the passage, and the opening or closing operation of the valve V and the on or off operation of the motors M₁-M₅ are controlled by the control device 100.

Reference symbol E₂ is a second cleaned paper-making material discharge path for discharging the paper-making material cleaned by the second screen S₂ and the second screen S′₂. The second cleaned paper-making material discharge path E₂ is located on the outflow side B′ of the paper-making material of the second screen S₂ and the second screen S′₂.

Reference numeral 30 denotes the second passage for connecting the inflow side A′ of the paper-making material of the second screen S₂ and the second screen S′₂ and the inflow side A″ of the paper-making material of the first screen S₁ so that the paper-making material containing the second foreign materials which can not be separated by the second screen S₂ and the second screen S′₂ is led to the inflow side A″ of the paper-making material of the first screen S₁.

Also, E₃ is the third cleaned paper-making material discharge path for discharging the paper-making material cleaned by the first screen S₁, and communicated with the outflow side B″ of the paper-making material of the first screen S₁.

Reference numeral 31 is the third foreign material discharge path for discharging the third foreign material which can not be separated by the first screen S₁, and communicates with the inflow side A″ of the paper-making material of the first screen S₁.

Therefore, when the paper-making material is supplied into the casing 2 through the material supply path 3, the papermaking material is directed toward an outer periphery from a lower center of the casing 2 to be supplied to the third to fifth screens S₃-S₅.

At that time, since the motors M₃-M₅ are rotated to rotate the agitating members A₃-A₅, while preventing the third to fifth screens S₃-S₅ from being clogged, the foreign materials are removed from the paper-making material. The paper-making material cleaned by the third to fifth screens S₃-S₅ is led outside the casing 2 through the first cleaned paper-making material discharge path E₁.

Incidentally, when quantities of the foreign materials in the paper-making materials on the inflow sides A of the third to fifth screens S₃-S₅ become large, the first opening-closing valve V for opening or closing the first passage 20 is opened and the motors M₂ and M′₂ are rotated by the control device 100, so that the paper-making material containing the first foreign material which can not be separated by the third to fifth screens S₃-S₅ is led to the inflow side A′ of the paper-making material of the second screens S₂ and S′₂ through the first passage 20. Then, the paper-making material cleaned by the second screens S₂ and S′₂ is discharged outside the casing 2 through the second cleaned papermaking material discharge path E₂.

Also, when quantities of the foreign material in the paper-making material on the inflow side A′ of the second screens S₂ and S′₂ become large, the second opening-closing valve V′ for opening or closing the second passage 30 is opened and the motor M₁ is rotated by the control device 100, so that the paper-making material containing the second foreign material which can not be separated by the second screens S₂ and S′₂ is led to the inflow side A″ of the paper-making material of the first screen S₁ through the second passage 30. Then, the paper-making material cleaned by the first screen S₁ is discharged outside the casing 2 through the third cleaned paper-making material discharge path E₃.

Incidentally, according to a state of the foreign material on the inflow side A″ of the first screen S₁, for example, when the quantities of the foreign material on the inflow side A″ of the first screen S₁ are large, the third opening-closing valve V″ provided to the third foreign material discharge path 31 is controlled by the control device 100 to be opened to thereby discharge the foreign material outside the casing 2 through the third foreign material discharge path 31.

As described above, the screen apparatus 1 includes the plural screens S₁-S₅ in the casing 2, and is structured such that the paper-making material is supplied altogether to the plural screens S₃-S₅ except for the first and second screens S₁, S₂, S′₂ through the material supply path 3 and the paper-making material cleaned by the plural screens S₃-S₅ except for the first and second screens S₁, S₂ and S′₂ is discharged altogether through the first cleaned paper-making material discharge path E₁. Thus, the screen apparatus 1 can be made compact.

Incidentally, the screen apparatus 1 can be operated according to an amount to be treated of the paper-making material such that in case a large amount of the paper-making material is treated, for example, the motors M₁-M₅ are turned on and the screens S₁-S₅ are all operated by the control device 100; on the other hand, when a slightly small amount of the paper-making material is treated, for example, one of the motors M₁-M₅ is turned off (for example, the motor M₂ is turned off and the motors M₁, motors M′₂-M₅ are turned on), and the five screens S₁, S′₂-S₅ are used. In other words, the screen apparatus 1 can cope with the amount to be treated of the paper-making material by operating the suitable number of the screens.

While, in Embodiment 9 described above, the six screens S₁-S₅ are provided, the present invention is not limited thereto. In the present invention, at least four screens, i.e. the first to fourth screens S₁-S₄ are required, for example, the second screen S′₂ and the fifth screen S₅ may be omitted; and at least four agitating members, such as the first agitating member A₁ for the first screen S₁, second agitating member A₂ for the second screen S₂, the third agitating member A₃ for the third screen S₃ and the fourth agitating member A₄ for the fourth screen S₄ are required. For example, the second agitating member A′₂ for the second screen S′₂ and the fifth agitating member A₅ for the fifth screen S₅ of the embodiment may be omitted. Further, the plural motors which rotate the agitators, such as the first motor M₁ for the first agitating member A₁, the second motor M₂ for the second agitating member A₂, the third motor M₃ for the third agitating member A₃ and the fourth motor M₄ for the fourth agitating member A₄ are required. For example, the second motor M′₂ and the fifth motor M₅ may be omitted. In this case, the control device 100 may be operated to control the on or off operation of the first, second, third and fourth motors M₁, M₂, M₃ and M₄.

Further, in the screen apparatus 1 of Embodiment 9, while the present invention is applied to a centripetal-type (external pressure-type) screen apparatus wherein the paper-making material flows from the outer side to the inner side of each screen to thereby clean the material, the present invention is not limited thereto. The present invention can also be applied to a centrifugal-type (internal pressure-type) screen apparatus wherein the paper-making material flows from the inner side to the outer side of each screen to thereby clean the material.

In the screen apparatus according to a first aspect of the invention, a plurality of screens is disposed in a casing, and a paper-making material can be supplied altogether to the plural screens through a material supply path to thereby make the screen apparatus compact.

In the screen apparatus according to a second aspect of the invention, in addition to the effects as stated above, a cleaned paper-making material discharge path is communicated with the outflow sides of the paper-making material of the respective screens, and the paper-making materials cleaned by the respective screens are discharged altogether outside the casing to thereby make the screen apparatus compact.

In the screen apparatus according to a third aspect of the invention, in addition to the effect of the first aspect, the on or off of a plurality of agitating members can be controlled by a control device to thereby cope with an amount to be treated of the paper-making material.

In the screen apparatus according to a fourth aspect of the invention, a plurality of screens is disposed in a casing and the paper-making material can be supplied altogether to the plural screens except for the first screen through a material supply path, so that the screen apparatus can be made compact.

In the screen apparatus according to a fifth aspect of the invention, in addition to the effect of the fourth aspect, the on or off of a plurality of agitating members can be controlled by a control device to thereby cope with an amount to be treated of the paper-making material.

In the screen apparatus according to a sixth aspect of the invention, in addition to the effect of the fourth aspect, an opening-closing valve provided in a passage can be controlled by the control device to thereby cope with the conditions of foreign materials on the inflow sides of the paper-making material of the second and third screens.

In the screen apparatus according to a seventh aspect of the invention, a plurality of screens is disposed in a casing and a paper-making material is supplied altogether to the plural screens except for the first and second screens by the material supply path to thereby make the screen apparatus compact.

In the screen apparatus according to an eighth aspect of the invention, in addition to the effect of the seventh aspect, the first and second opening-closing valves disposed in the first and second passages can be controlled by the control device to thereby cope with conditions of foreign materials on the inflow sides of the paper-making material of the third and fourth screens or an inflow side of the paper-making material of the second screen.

While the invention has been explained with reference to the specific embodiments of the invention, the explanation is illustrative and the invention is limited only by the appended claims.

What is claimed is:

1. A screen apparatus comprising:
a casing;
a material supply path connected to the casing for supplying a paper-making material into the casing;
a plurality of screens disposed in the casing, each having an inflow side and an outflow side for the paper-making material, at least one of said inflow sides communicating with the material supply path;
a plurality of agitating members provided to the respective screens;
a paper-making material discharge path formed in the casing to communicate with at least one of the outflow sides of the screens for discharging the paper-making material passing through the at least one of the screens; and
a foreign material discharge path formed in the casing to communicate with at least one-of the inflow sides of the screens, said foreign material discharge path discharging a foreign material which does not pass through one of the screens communicating with the material supply path.

2. A screen apparatus as claimed in claim 1, wherein said papermaking material discharge path communicates with the outflow sides of the screens to discharge the paper-making material passing through the screens outside the casing.

3. A screen apparatus as claimed in claim 1, further comprising a plurality of motors connected to the plural agitating members to rotate the same, and a control device connected to the motors for controlling the same.

4. A screen apparatus as claimed in claim 1, wherein said plurality of screens is arranged in the casing laterally side by side with a space therebetween, said inflow sides or the outflow sides being located above the screens.

5. A screen apparatus as claimed in claim 1, wherein said plurality of screens includes at least a first screen, and second and third screens separated from the first screen, said inflow sides of the second and third screens communicating with the material supply path and the outflow sides of the second and third screens communicating with the paper-making material discharge path to discharge the paper-making material passing through the second and third screens;
said screen apparatus further comprising a first passage connecting the inflow sides of the second and third screens and the inflow side of the first screen to lead the paper-making material containing a foreign material not passing through the second and third screens to the inflow side of the first screen; and
a secondary paper-making material discharge path communicating with the outflow side of the first screen for discharging the paper-making material passing through the first screen, the inflow side of the first screen being connected to the foreign material discharge path for discharging the foreign material not passing through the first screen.

6. A screen apparatus as claimed in claim 5, further comprising a plurality of motors for rotating the agitating members for the first, second and third screens, and a control device for controlling operations of the motors.

7. A screen apparatus as claimed in claim 5, further comprising an opening-closing valve situated in the first passage for opening or closing the first passage, and a control device connected to the opening-closing valve for controlling the same.

8. A screen apparatus as claimed in claim 5, wherein said plurality of screens further includes a fourth screen separated from the first, second and third screens,
said screen apparatus further comprising a second passage for connecting the inflow side of the fourth screen and the inflow sides of the second and third screens, and a ternary paper-making material discharge path connected to the outflow side of the fourth screen for discharging a paper-making material passing through the fourth screen, the inflow side of the fourth screen being connected to the first passage for providing a paper-making material not passing through the fourth screen to the first screen.

9. A screen apparatus as claimed in claim 8, further comprising a first opening-closing valve connected to the first passage, a second opening-closing valve connected to the second passage, and a control device for controlling the first and second opening-closing valves.
